(19) United States
(12) Patent Application Publication
(10) Pub. No.: US 2012/0147525 A1
(43) Pub. Date: Jun. 14, 2012

(54) ELECTRIC DOUBLE LAYER CAPACITOR

(75) Inventors: Senughyun Ra, Gyeonggi-do (KR); Younghak Jeong, Gyeonggi-do (KR)

(73) Assignee: SAMSUNG ELECTRO-MECHANICS CO., LTD.

(21) Appl. No.: 13/071,021

(22) Filed: Mar. 24, 2011

(30) Foreign Application Priority Data
Dec. 14, 2010 (KR) 10-2010-0127346

(51) Int. Cl. H01G 9/155

(52) U.S. Cl. 361/502

(57) ABSTRACT

Disclosed herein is an electric double layer capacitor including electrode assemblies configured of current collectors having a positive electrode or a negative electrode formed on surfaces thereof and a separator, the electric double layer capacitor including a housing having both opposite sides opened so that the electrode assemblies are received therein and external terminals each provided on both opened sides of the housing and connected to the current collectors to reduce internal equivalent series resistance (ESR), thereby generating high output characteristics.

### CROSS REFERENCE(S) TO RELATED APPLICATIONS

This application claims the benefit under 35 U.S.C. Section [120, 119, 119(e)] of Korean Patent Application Serial No. 10-2010-0127346, entitled “Electric Double Layer Capacitor” filed on Dec. 14, 2010, which is hereby incorporated by reference in its entirety into this application.

### BACKGROUND OF THE INVENTION

1. Technical Field

The present invention relates to an electric double layer capacitor, and more particular, to an electric double layer capacitor including electrode assemblies configured of current collectors having a positive electrode or a negative electrode formed on surfaces thereof and a separator, the electric double layer capacitor including a housing having both opposite sides opened so that the electrode assemblies may be received therein and external terminals each provided on both opened sides of the housing and connected to the current collectors to reduce internal equivalent series resistance (ESR), thereby generating high output characteristics.

2. Description of the Related Art

An electric double layer capacitor, which is an energy storage medium having intermediate characteristics between a secondary battery and a capacitor, stores charges in an ionic layer called an electric double layer formed on an interface between electrolytes, unlike a battery using chemical reaction as a mechanism of storing electricity.

Generally, the electric double layer in which positive charges on one side of a thin film layer of an object and negative charges on the other side thereof are continuously disposed or are distributed in a state having surface density identical to each other indicates a double layer mainly configured of a dipole. Typically, the charges are rearranged and an electric double layer is formed, on an interface between different materials.

In addition, the electric double layer capacitor using the electric double layer in which an electrostatic layer is formed on an interface between an activated carbon electrode and organic electrolyte and the electric double layer is used as a dielectric to store electric energy, similar to the battery uses the principle that the charges are adsorbed to and desorbed from the electric double layer on an interface between a solid electrode and electrolyte.

The electric double layer capacitor has lower energy density, however, has more excellent discharge characteristics instantaneously generating high current and high output, as compared to the battery, and has cycle characteristics of several hundred thousand times, which provides a semi-permanent lifespan.

Accordingly, the electric double layer capacitor may substitute for the battery requiring long lifespan, without requiring a lot of energy, and has been used as a backup power supply for a memory device, a battery for a portable information device, and a battery for a hybrid electric vehicle.

As the electric double layer capacitor, there are a cylindrical shaped electric double layer capacitor, a prism shaped electric double layer capacitor, a coin shaped electric double layer capacitor, a lug shaped electric double layer capacitor, a pouch shaped electric double layer capacitor, and the like according to a shape thereof. Among them, the prism shaped electric double layer capacitor, which has a structure in which a pair of electrodes formed by applying an active material to a surface of an aluminum current collector is disposed to be opposite to each other, having a separator therebetween, has a simple terminal drawing-out scheme.

In addition, the prism shaped electric double layer capacitor has a wide opposite area between electrodes, has a thinned thickness of an activated carbon electrode to reduce diffusion resistance in electrode bodies, has larger capacitance and higher output than the coil shape electric double layer capacitor, and may be used for a large current load.

However, in order to maintain high output characteristics, which are properties always required, it is important to reduce internal ESR. Factors which have an influence on the ESR are a connection between the current collector and the electrode, electrolyte resistance, resistance with an external electrode, an interval between electrodes, and the like. Particularly, the development of an electric double layer capacitor, in which contact area between the current collector and the electrode in the connection therebetween is maximized to reduce internal ESR, thereby providing high output characteristics, has been demanded.

### SUMMARY OF THE INVENTION

An object of the present invention is to provide an electric double layer capacitor including electrode assemblies configured of current collectors having a positive electrode or a negative electrode formed on surfaces thereof and a separator, the electric double layer capacitor including a housing having both opposite sides opened so that the electrode assemblies may be received therein and external terminals each provided on both opened sides of the housing and connected to the current collectors to reduce internal equivalent series resistance (ESR), thereby generating high output characteristics.

According to an exemplary embodiment of the present invention, there is provided an electric double layer capacitor including electrode assemblies configured of current collectors having a positive electrode or a negative electrode formed on surfaces thereof and a separator, the electric double layer capacitor including: a housing having both opposite sides opened so that the electrode assemblies are received therein; and external terminals each provided on both opened sides of the housing and connected to the current collectors.

The electrode assemblies may be formed in plural.

An end of the current collector having the positive electrode formed on a surface thereof may be disposed in an opposite direction to an end of the current collector having the negative electrode formed on a surface thereof, the ends being connected to the external terminals.

The electrode assembly may be formed by flatly winding the current collectors having the positive electrode or the negative electrode formed on the surfaces thereof and the separator.

The housing may further include a safety valve.

### BRIEF DESCRIPTION OF THE DRAWINGS

FIG. 1 is a top view of an electrode assembly used for an electric double layer capacitor according to an exemplary embodiment of the present invention;

FIG. 2 is a cross-sectional view of the electrode assembly of FIG. 1;

FIG. 3 is a cross-sectional view of an electric double layer capacitor formed by stacking and packaging a plurality of (three) electrode assemblies, according to an exemplary embodiment of the present invention;

FIG. 4 is a top view of the electric double layer capacitor of FIG. 3;

FIG. 5 is a cross-sectional view of an electric double layer capacitor formed by stacking and packaging a plurality of (three) electrode assemblies, according to another exemplary embodiment of the present invention; and

FIG. 6 is a top view of the electric double layer capacitor of FIG. 5.

### DESCRIPTION OF THE PREFERRED EMBODIMENTS

Hereinafter, exemplary embodiments will be described in detail with reference to the accompanying drawings so that they can be easily practiced by those skilled in the art to which the present invention pertains.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

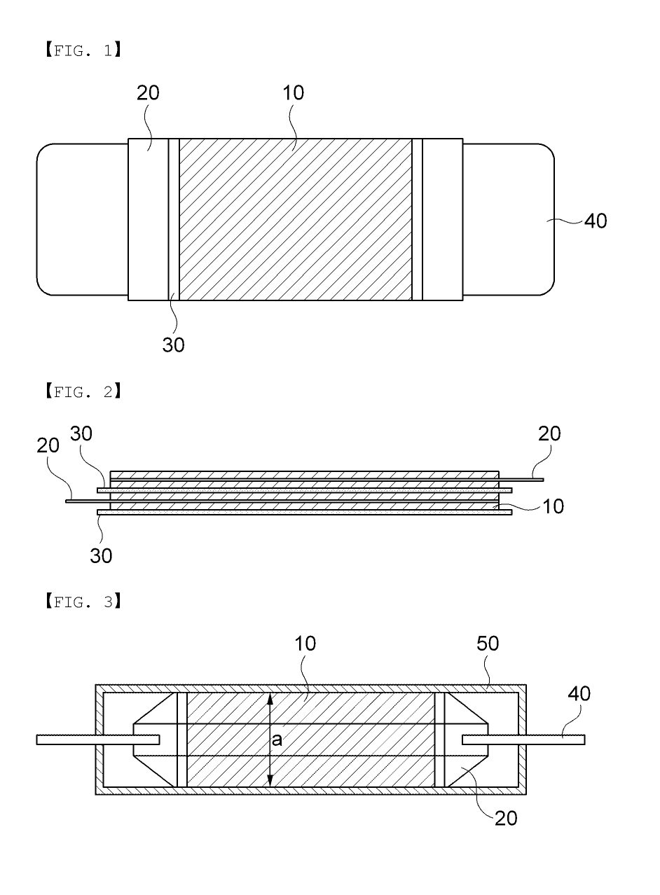

FIG. 1 is a top view of an electrode assembly A used for an electric double layer capacitor according to an exemplary embodiment of the present invention and including external terminals 40.

An electrode assembly A used for an electric double layer capacitor according to an exemplary embodiment of the present invention is configured to include electrodes 10 including a positive electrode and a negative electrode, current collectors 20 having the electrodes 10 formed on surfaces thereof, and a separator 30 separating the electrodes 10 from each other.

Referring to FIG. 2, a specific structure of the electrode assembly A including the external terminals 40 of FIG. 1 may be appreciated.

First, the electrodes 10 include the positive and negative electrodes, and the same electrode is coated on both surfaces of the current collector 20.

In this configuration, the electrodes 10 are coated so that only ends of one side of the current collectors 20 are exposed, wherein the exposed ends of the current collectors having each of the electrodes 10 coated thereon are disposed in an opposite direction to each other. That is, when the exposed end of one side of the current collector 20 having the positive electrode coated on a surface thereof is disposed on the right, the exposed end of the other side of the current collector 20 having the negative electrode coated on a surface thereof is disposed on the left.

The current collector 20 having the positive electrode coated on a surface thereof and the current collector 20 having the negative electrode coated on a surface thereof are stacked, having the separator 30 therebetween, and are flatly wound to complete the electrode assembly A.

The current collectors of the completed electrode assembly A are connected to the external terminals 40. Since the exposed ends of the current collectors 20 having the negative and positive electrodes each coated on a surface thereof are formed in an opposite direction to each other in the electrode assembly A according to an exemplary embodiment of the present invention, the external terminals 40 are also connected to the current collectors in an opposite direction to each other.

FIG. 3 is a cross-sectional view of an electric double layer capacitor formed by stacking and packaging a plurality of (three) electrode assemblies A, according to an exemplary embodiment of the present invention. An electric double layer capacitor according to an exemplary embodiment of the present invention shown in FIG. 3 is manufactured by using a following method.

First, a plurality of (three in the drawing) electrode assemblies A completed by stacking the current collector 20 having the positive electrode coated on a surface thereof and the current collector 20 having the negative electrode coated on a surface thereof, having the separator 30 therebetween, and then flatly winding them are stacked.

Then, the external terminals 40 are fused to the current collector exposed from each of the stacked electrode assemblies A in both directions by welding or ultrasonic waves.

Next, the plurality electrode assemblies A having the external terminals 40 fused thereto are introduced into a housing 50.

In this configuration, the housing 50 has both opposite sides opened so that the plurality of electrode assemblies A having the external terminals 40 fused thereto may be received therein.

The housing 50, which is a case made of a polymer material, has a space formed in an inner portion thereof, the space receiving the electrode assembly A and electrolyte. In this configuration, the polymer includes polyurethane and Teflon, and has strength of 200 kgf/cm² or more.

In this configuration, the electrode assemblies A having the external terminals 40 fused thereto may be introduced into the housing 50, while the number thereof is adjusted, so that there is no extra space within the housing 50. In this case, a thickness of the stacked electrode assemblies A should be the same as a width of the housing.

Then, the external terminals 40 fused to the electrode assemblies A are exposed through both opened sides of the housing 50, and both opened sides of the housing 50 are sealed together with the external terminals 40.

In this case, the sealing may be performed using all methods capable of being adopted by those skilled in the art, such as a welding method, a curling method, or the like.

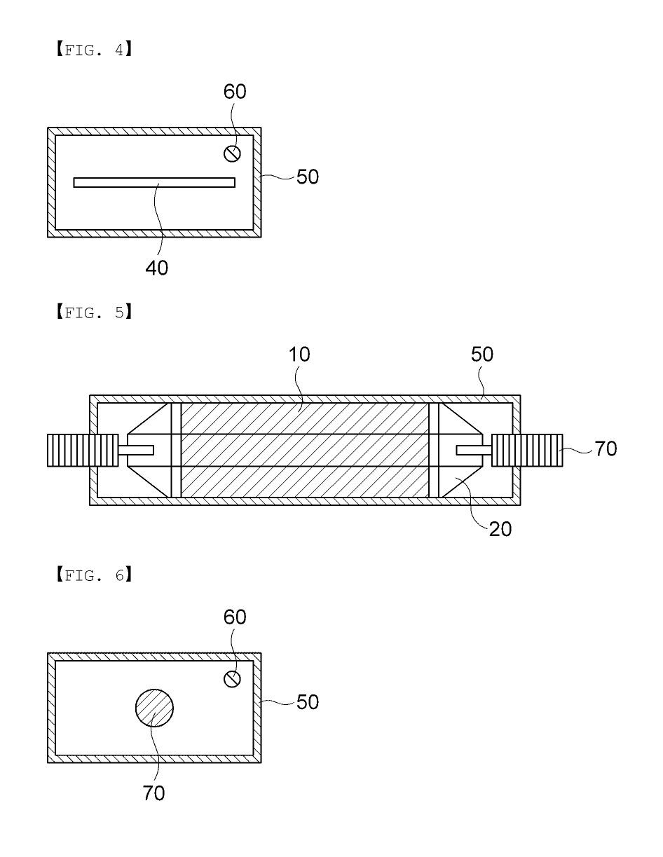

In this configuration, one side of both sealed sides of the housing 50 is formed with a safety valve 60 for protecting the housing 50 from pressure increase due to gas, or the like, capable of occurring in the inner portion of the housing 50, and injecting electrolyte, which may be appreciated in FIG. 4 which is a top view of the electric double layer capacitor of FIG. 3.

Meanwhile, an electric double layer capacitor according to another exemplary embodiment of the present invention may be formed by connecting tabs 70 to the external terminals 40 in the inner portion of the housing 50 and then packaging them. FIG. 5 is a cross-sectional view of the electric double layer according to another exemplary embodiment of the present invention, and FIG. 6 is a top view of the electric double layer capacitor of FIG. 5. It may be appreciated in FIGS. 5 and 6 that the taps 70 connected to the external terminals 40 are exposed to an outer portion of the housing 50.

According to the exemplary embodiments of the present invention, a contact area between the current collector and the electrode is increased to reduce ESR, thereby making it possible to manufacture the electric double layer capacitor having large capacitance. In addition, the external terminals are formed on both sides to be easily coupled to a module.

With the electric double layer capacitor according to the exemplary embodiments of the present invention, a positive electrode external terminal and a negative electrode external terminal are disposed in an opposite direction to each other to be easily coupled to a module and an area of the current collector connected to the external terminal is increased to reduce the ESR, thereby making it possible to generate high output characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An electric double layer capacitor including electrode assemblies configured of current collectors having a positive electrode or a negative electrode formed on surfaces thereof and a separator, the electric double layer capacitor comprising:
a housing having both opposite sides opened so that the electrode assemblies are received therein; and
external terminals each provided on both opened sides of the housing and connected to the current collectors.

2. The electric double layer capacitor according to claim 1, wherein the electrode assemblies are formed in plural.

3. The electric double layer capacitor according to claim 1, wherein an end of the current collector having the positive electrode formed on a surface thereof is disposed in an opposite direction to an end of the current collector having the negative electrode formed on a surface thereof, the ends being connected to the external terminals.

4. The electric double layer capacitor according to claim 1, wherein the electrode assembly is formed by flatly winding the current collectors having the positive electrode or the negative electrode formed on the surfaces thereof and the separator.

5. The electric double layer capacitor according to claim 1, wherein the housing further includes a safety valve.
